(19) United States
(12) Patent Application Publication
(10) Pub. No.: US 2024/0102501 A1
(43) Pub. Date: Mar. 28, 2024

(54) SCREW FASTENING STRUCTURE, ASSEMBLY STRUCTURE, AND IMAGE FORMING APPARATUS

(71) Applicant: FUJIFILM Business Innovation Corp., Tokyo (JP)

(72) Inventor: Hiroyuki KONO, Kanagawa (JP)

(73) Assignee: FUJIFILM Business Innovation Corp., Tokyo (JP)

(21) Appl. No.: 18/182,843

(22) Filed: Mar. 13, 2023

(30) Foreign Application Priority Data
Sep. 28, 2022 (JP) 2022-155021

(51) Int. Cl. F16B 5/02

(52) U.S. Cl. CPC F16B 5/02; F16B 2200/503

(57) ABSTRACT

A screw fastening structure includes: a screw fastener having a threaded portion; and a fastening assist member having a flanged screw hole, a through-hole through which the threaded portion of the screw fastener passes, and a folded part folded back such that the screw hole and the through-hole face each other. A flange of the screw hole projects toward a side opposite to a side of the through-hole, and the threaded portion of the screw fastener is fastened to the screw hole after passing through the through-hole.

### CROSS-REFERENCE TO RELATED APPLICATIONS

This application is based on and claims priority under 35 USC 119 from Japanese Patent Application No. 2022-155021 filed Sep. 28, 2022.

### BACKGROUND

### (i) Technical Field

The present disclosure relates to a screw fastening structure, an assembly structure, and an image forming apparatus.

### (ii) Related Art

Japanese Unexamined Patent Application Publication No. 10-26359 (paragraph [0010], FIG. 3) discloses a planar mounting plate for an air conditioner. The mounting plate is configured to be fixed to mounting bars at the left and right sides thereof with screws.

The mounting plate has vertically extending bending portions at positions closer to the center than the left and right ends. Multiple flanged holes are formed on one side of each bending portion, and through-holes corresponding to the flanged holes are provided on the other side of the bending portion. The left and right ends of the mounting plate are bent inward by 180 degrees at the bending portions, and then, the mounting plate is fixed to the mounting bars with screws.

Japanese Unexamined Patent Application Publication No. 2004-11679 (paragraphs [0015]-[0019], FIG. 1) discloses a thin-plate-portion fastening structure including a first thin-plate portion, a second thin-plate portion having a folded portion, and a screw that is screwed so as to penetrate through the first thin-plate portion and the folded portion.

Japanese Unexamined Patent Application Publication No. 2014-9698 (claim 1, FIG. 3) discloses an assembly structure including a female thread member having a female thread, an insertion-hole member having an insertion hole positioned with respect to the female thread, and a male thread member to be screwed into the female thread through the insertion hole so that the insertion-hole member is fixed to the female thread member.

The female thread member has a folded portion formed by folding a part of a metal plate constituting the female thread member in two, and a pilot hole penetrating through the metal plates forming the folded portion. The female thread is formed in the pilot hole so as to penetrate through the layers of metal plate forming the folded portion. In a state in which the male thread member is screwed, the layers of metal plate forming the folded portion are in tight contact with each other.

### SUMMARY

Aspects of non-limiting embodiments of the present disclosure relate to providing a screw fastening structure capable of suppressing deformation of a flange, which has been made to project by performing a burring process on a screw hole, in such a manner that the flange sinks, due to fastening of a screw fastener, and to provide an assembly structure and an image forming apparatus employing the fastening structure. The screw fastening structure has a fastening assist member having a folded part folded back such that a screw hole and a through-hole through which a threaded portion of the screw fastener passes face each other. The flange of the screw hole projects toward the side opposite to the through-hole, and the threaded portion of the screw fastener is fastened to the screw hole after passing through the through-hole.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a screw fastening structure including: a screw fastener having a threaded portion; and a fastening assist member having a flanged screw hole, a through-hole through which the threaded portion of the screw fastener passes, and a folded part folded back such that the screw hole and the through-hole face each other, wherein a flange of the screw hole projects toward a side opposite to a side of the through-hole, and the threaded portion of the screw fastener is fastened to the screw hole after passing through the through-hole.

### BRIEF DESCRIPTION OF THE DRAWINGS

Exemplary embodiments of the present disclosure will be described in detail based on the following figures, wherein:

FIG. 1 is a schematic sectional view of an assembly structure employing a screw fastening structure according to a first exemplary embodiment;

FIG. 2 is a schematic exploded sectional view of the assembly structure in FIG. 1;

FIG. 3A is a schematic sectional view of a screw-fastened structural part, and FIG. 3B is a schematic sectional view of a part of the screw fastening structure;

FIGS. 4A and 4B are schematic sectional views of a folded part according to a first modification and a second modification, respectively;

FIG. 5 is a schematic sectional view of a folded part according to a third modification;

FIGS. 6A and 6B schematically show an image forming apparatus having a screw fastening structure according to a second exemplary embodiment; and

FIG. 7A is a schematic sectional view of a part of a screw fastening structure according to a comparative example, and FIG. 7B is a schematic sectional view showing a defective state occurring with the screw fastening structure shown in FIG. 7A.

### DETAILED DESCRIPTION

Exemplary embodiments of the present disclosure will be described below.

### First Exemplary Embodiment

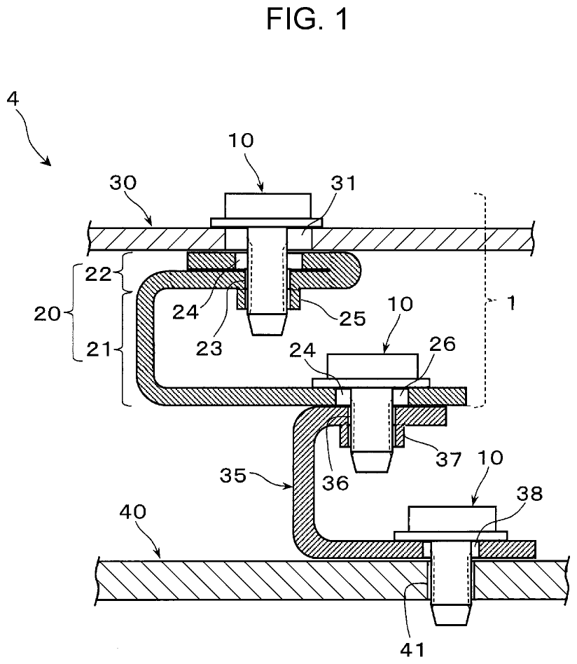

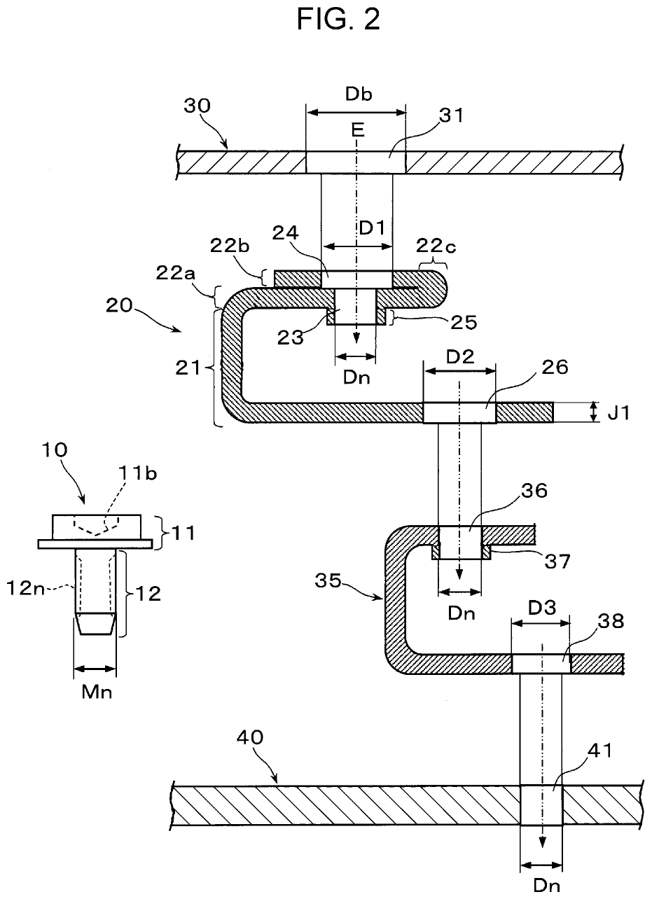

FIG. 1 schematically shows an assembly structure 4 employing a screw fastening structure 1 according to a first exemplary embodiment of the present disclosure. FIG. 2 schematically shows the assembly structure 4 in an exploded state.

In the specification and drawings, substantially the same components are denoted by the same reference signs, and repeated description of such components will be omitted.

### Assembly Structure

As shown in FIG. 1, the assembly structure 4 includes at least a member to be fastened 30, and the screw fastening structure 1 via which the member to be fastened 30 is fastened to a fastening assist member 20 with a screw fastener 10.

Assembly of the assembly structure 4 includes an assembly step in which the member to be fastened 30 is fastened to the fastening assist member 20 with the screw fastener 10 of the screw fastening structure 1.

Hence, the assembly structure 4 is either the whole or a part of a structure, such as a device, an apparatus, or a component. Examples of a part of a structure include a structural part and a component.

The member to be fastened 30 is a member to be attached to a certain fastening counterpart via the screw fastening structure 1. Typically, the member to be fastened 30 is a plate-like member as a whole, but may be a member having a plate-like shape at a portion to be screw-fastened and having another shape at the other portion.

Examples of the member to be fastened 30 include a member to be screw-fastened at the final stage, such as an exterior member (outer cover), a covering member (inner cover), or a final component, and a member to be screw-fastened at an intermediate stage, such as a built-in component, an inner component, or an attachment assist member (such as a bracket).

The member to be fastened 30 has, at a certain position thereof, a circular large-diameter through-hole 31 having a certain diameter Db, through which a threaded portion 12 of the screw fastener 10 passes when the member to be fastened 30 is fastened with the screw fastener 10. The large-diameter through-hole 31 is a through-hole having a diameter Db, which is greater than a diameter D1 (Db>D1) of a through-hole 24 provided in a folded part 22 (described below) of the screw fastening structure 1.

As shown in FIG. 1, the assembly structure 4 according to the first exemplary embodiment also includes: an attachment assist member 35, to which the fastening assist member 20 of the screw fastening structure 1, to which the member to be fastened 30 is fastened, is attached with a screw; and a support body 40 to which the attachment assist member 35 is attached with a screw.

### Screw Fastening Structure

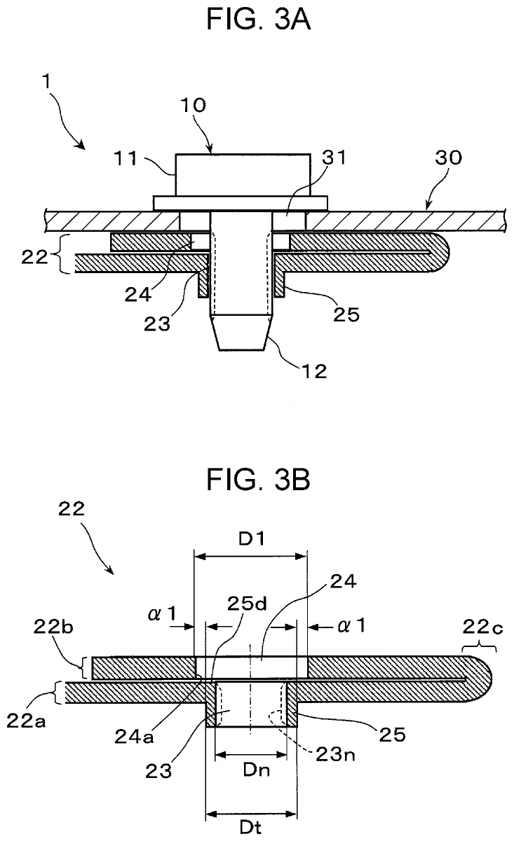

As shown in FIGS. 1 and 3A, the screw fastening structure 1 includes at least the screw fastener 10 and the fastening assist member 20.

The screw fastener 10 is a fixture that is to be screwed to fix an object to be fastened. As shown in FIG. 2, the screw fastener 10 has a fixing portion 11 and the threaded portion 12. Although, normally, the fixing portion 11 and the threaded portion 12 are formed as a single component, they may be formed as separate components that are integrated when used.

The fixing portion 11 is a portion that is pressed against and fixes the member to be fastened 30 when the member to be fastened 30 is fastened with the screw fastener 10. The fixing portion 11 may have any shape as long as it has a larger diameter than the threaded portion 12 and it can be in contact with and fix the member to be fastened 30.

The fixing portion 11 has a recess 11b in the upper surface thereof to receive a tool, such as a plus or minus screwdriver or a multi-angle wrench, when the screw fastener 10 is turned. The fixing portion 11 may also have a certain shape, such as a nut thread or a non-slip unevenness, on the side surface thereof. The fixing portion 11 may have both the recess 11b in the upper surface and the nut thread in the side surface thereof.

The threaded portion 12 is provided on one side of the fixing portion 11 and has a body portion extending in a cylindrical shape or a body portion extending in a cylindrical shape and tapering in a conical shape at the end. The threaded portion 12 has a male thread 12n with a certain diameter Mn on the outer circumferential surface of the body portion thereof.

As shown in FIGS. 1 and 2, the fastening assist member 20 is a plate-like member having a flanged screw hole 23, a through-hole 24 through which the threaded portion 12 of the screw fastener 10 passes, and the folded part 22 folded back such that the screw hole 23 and the through-hole 24 face each other.

The fastening assist member 20 is made of, for example, metal.

As shown in FIG. 2, the fastening assist member 20 according to the first exemplary embodiment is a plate-like member having a body part 21 and the folded part 22 provided at a part of the body part 21.

The body part 21 has, for example, a shape including a substantially planar substrate portion and a bent portion formed by bending one end of the substrate portion at a substantially right angle. As shown in FIG. 2, the body part 21 has a second through-hole 26 through which the threaded portion 12 of a screw fastener 10 for attaching the fastening assist member 20 to the attachment assist member 35 (described below) passes.

The folded part 22 is provided such that the body part 21 is folded again at a substantially right angle at the end of the bent portion thereof.

The folded part 22 is a portion where a part of the fastening assist member 20 is folded into two.

As shown in FIGS. 2 and 3B, the folded part 22 includes a base portion 22a, which is one portion thereof, and a folded portion 22b, which is the other portion thereof. The folded portion 22b is formed by folding back one end of the base portion 22a. The base portion 22a is provided at an angle with respect to the bent portion of the body part 21 of the fastening assist member 20, at one end thereof.

As shown in FIG. 3B, the folded part 22 also includes a bent portion 22c that is bent at the time of folding back.

As shown in FIG. 3B, the screw hole 23 is a circular screw hole formed by burring and having a certain diameter Dn. The screw hole 23 is provided in the base portion 22a of the folded part 22 of the fastening assist member 20.

As shown in FIGS. 2 and 3B, the screw hole 23 has a cylindrical flange 25 that is made to project from one side of the base portion 22a at the time of a burring process. As shown in FIG. 3B, the flange 25 has, in the inner circumferential surface thereof, a female thread 23n into which the male thread 12n of the threaded portion 12 of the screw fastener 10 is screwed.

As shown in FIG. 3B, the through-hole 24 is a circular hole having a certain diameter D1. The through-hole 24 is provided in the folded portion 22b of the folded part 22 of the fastening assist member 20.

The diameter D1 of the through-hole 24 is greater than the diameter Mn of the threaded portion 12 (D1>Mn) so that the threaded portion 12 of the screw fastener 10 can pass through the through-hole 24.

Furthermore, as shown in FIG. 3B, an edge 24a, serving as an opening end, of the through-hole 24 is provided at a position as close to a bending root portion 25d of the flange 25 of the screw hole 23 as possible.

The bending root portion 25d of the flange 25 is a portion of the base portion 22a of the folded part 22 having the screw hole 23, the portion corresponding to the thickness of the flange 25.

Providing the edge 24a of the through-hole 24 at a position as close to the bending root portion 25d as possible means reducing the distance α1 between the edge 24a of the through-hole 24 and the outer circumferential portion of the flange 25 of the screw hole 23 as much as possible. Although the distance α1 varies with the diameter Dn of the screw hole 23, the distance α1 is preferably smaller than 1 mm.

Furthermore, the diameter D1 of the through-hole 24 is greater than the diameter Dt of the outer circumferential portion of the flange 25 of the screw hole 23 (see FIG. 3B) and smaller than the diameter Db of a large-diameter through-hole 31 in the member 30 to be fastened (see FIG. 2).

As shown in FIG. 3B, the folded part 22 is folded back such that the screw hole 23 and the through-hole 24 concentrically face each other.

It is preferable that the screw hole 23 and the through-hole 24 concentrically face each other in the folded part 22. One-dot chain line in FIG. 3B indicates that the screw hole 23 and the through-hole 24 are concentric.

As shown in FIGS. 1, 2, 3A, etc., in the screw fastening structure 1, the flange 25 of the screw hole 23 projects toward the side opposite to the through-hole 24.

In other words, the flange 25 of the screw hole 23 projects toward the side opposite to the side where the folded portion 22b having the through-hole 24 is present.

Furthermore, in the screw fastening structure 1, as shown by a two-dot chain line E with an arrowhead in FIG. 2, the threaded portion 12 of the screw fastener 10 is fastened to the screw hole 23 after passing through the through-hole 24. As a result, the male thread 12n on the threaded portion 12 of the screw fastener 10 is screwed into the female thread 23n in the screw hole 23.

Furthermore, as shown in FIG. 3B and the like, in the folded part 22 according to the first exemplary embodiment, the base portion 22a having the screw hole 23 and the folded portion 22b having the through-hole 24 are laid on each other so as to be in contact with each other over the entire area where they face each other.

As a result, the base portion 22a and the folded portion 22b of the folded part 22 are in contact with each other over the entire area where they face each other without any intentional clearance.

Furthermore, it is preferable that the diameter D2 of the second through-hole 26 in the fastening assist member 20 according to the first embodiment be equal to the diameter D1 of the through-hole 24 in the folded part 22 when a second screw hole 36 (described below) in the attachment assist member 35 is a flanged screw hole and to which a screw fastener 10 is to be fastened in the same manner as above.

Screw Fastening with Screw Fastening Structure

As shown in FIGS. 1 and 3A, the screw fastening structure 1 is usually used to fasten the member to be fastened 30, which has the large-diameter through-hole 31, to the folded part 22 of the fastening assist member 20 with the screw fastener 10.

In this case, as shown in FIG. 3A, the threaded portion 12 of the screw fastener 10 is let through the large-diameter through-hole 31 in the member to be fastened 30, then through the through-hole 24 in the folded part 22, and is fastened to the screw hole 23.

With this configuration, when the threaded portion 12 of the screw fastener 10 is fastened to the screw hole 23, the fixing portion 11 of the screw fastener 10 is in contact with the periphery of the large-diameter through-hole 31 and is pressed against the folded portion 22b of the folded part 22 of the fastening assist member 20, and thus, the member to be fastened 30 is fixed. In other words, the member to be fastened 30 is fastened to the folded part 22 of the fastening assist member 20 with the screw fastener 10.

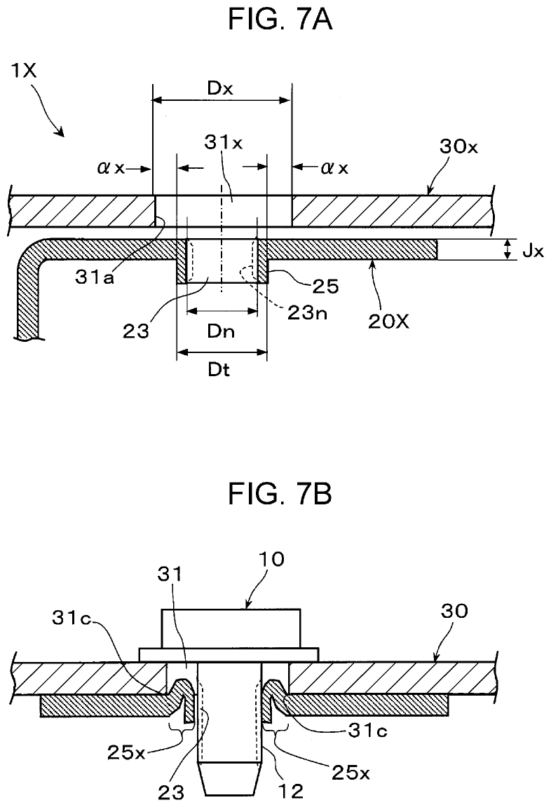

In the screw fastening structure 1, compared with a screw fastening structure 1X according to a comparative example as shown in FIG. 7A, when the screw fastener 10 is fastened to the screw hole 23, deformation of the flange 25 of the screw hole 23 in such a manner that the flange 25 sinks (see FIG. 7B) is suppressed.

As shown in FIG. 7A, the screw fastening structure 1X according to the comparative example includes the screw fastener 10 and a fastening assist member 20x having a flanged screw hole 23 in a portion that is not folded back.

In other words, the screw fastening structure 1X according to the comparative example does not have the configuration as in the screw fastening structure 1 according to the first exemplary embodiment, in which, in the fastening assist member 20 having the folded part 22 folded back such that the screw hole 23 and the through-hole 24 for the threaded portion 12 of the screw fastener 10 face each other, the flange 25 of the screw hole 23 projects toward the side opposite to the through-hole 24, and the threaded portion 12 of the screw fastener 10 passes through the through-hole 24 and is fastened to the screw hole 23.

In the screw fastening structure 1X according to the comparative example, when the screw fastener 10 is fastened to the screw hole 23, the flange 25 of the screw hole 23 may be deformed so as to buckle and sink into the through-hole 24 as shown in FIG. 7B.

The deformation occurs as if the flange 25 starts to be bent at an opening corner 31c of the large-diameter through-hole 31 in the member to be fastened 30.

The deformation tends to occur more easily if the thickness Jx of the fastening assist member 20x is smaller than 1 mm from the standpoint of reducing weight or the like.

This deformation leads to screw breakage, in which the female thread in the screw hole 23 cannot properly mesh with the male thread on the threaded portion 12 of the screw fastener 10.

Furthermore, as shown in FIG. 7A, the greater the distance ax between an edge 31a of the large-diameter through-hole 31 in the member to be fastened 30 and the bending root portion or the outer circumferential portion of the flange 25 of the screw hole 23, the more likely this deformation is to occur.

The distance ax at this time is at least greater than the distance α1 (see FIG. 3B) in the screw fastening structure 1 according to the first exemplary embodiment (αx>α1).

In other words, this is also the case where the diameter Dx of a large-diameter through-hole 31x in a member to be fastened 30x is greater than the diameter D1 of the through-hole 24 in the screw fastening structure 1 according to the first exemplary embodiment.

However, the diameter Dx of the large-diameter through-hole 31x may be equal to the diameter D1 of the large-diameter through-hole 24 in the member to be fastened 30 used in the screw fastening structure 1 according to the first exemplary embodiment. The diameter Dx of the large-diameter through-hole 31x may be greater than the diameter D1 of the large-diameter through-hole 24.

In the screw fastening structure 1 according to the first exemplary embodiment, in either case where the thickness J1 of the entire fastening assist member 20 (or at least the folded part 22) is smaller than 1 mm or where the diameter Db of the large-diameter through-hole 31 in the member to be fastened 30 is greater than the diameter D1 of the through-hole 24, deformation of the flange 25 of the screw hole 23 due to fastening of the screw fastener 10 is suppressed.

In the screw fastening structure 1 according to the first exemplary embodiment, in the folded part 22 of the fastening assist member 20, the base portion 22a having the screw hole 23 and the folded portion 22b having the through-hole 24 are laid on each other so as to be in contact with each other over the entire area where they face each other (see FIG. 3B).

Therefore, in the screw fastening structure 1, compared with a case where the base portion 22a and the folded portion 22b of the folded part 22 are partially separated from each other in the area where they face each other, the strength of the folded part 22 is high, and deformation of the flange 25 of the screw hole 23 in such a manner that it sinks as the screw fastener 10 is fastened is suppressed.

### Detailed Configuration of Assembly Structure

In the assembly structure 4 according to the first exemplary embodiment, not only the member to be fastened 30 is screw-fastened to the folded part 22 of the fastening assist member 20 of the screw fastening structure 1, but also, as shown in FIG. 1, the fastening assist member 20 is screw-fastened and attached to the attachment assist member 35, and the attachment assist member 35 is screw-fastened to and supported by the support body 40.

The attachment assist member 35 is a member to be screw-fastened to another member during assembly and to which the member to be fastened 30 is screw-fastened and attached.

The attachment assist member 35 according to the first exemplary embodiment is configured as, for example, a plate-like member (bracket) that is bent to have a U-shaped cross section.

The attachment assist member 35 has a flanged circular second screw hole 36 having a diameter Dn at a portion to which the fastening assist member 20 is to be screw-fastened. The diameter Dn of the second screw hole 36 is equal to the diameter Dn of the screw hole 23 when a screw fastener the same as the screw fastener 10 is used.

Furthermore, a circular third through-hole 38 having a diameter D3, through which the threaded portion 12 of a screw fastener 10 passes, is provided in a portion of the attachment assist member 35 to be screw-fastened to the support body 40. The diameter D3 of the third through-hole 38 is greater than the diameter Mn of the threaded portion 12 of the screw fastener 10 and is smaller than or equal to the diameter D1 of the through-hole 24 (Mn<D3≤D1).

The support body 40 is a structure to which the attachment assist member 35 is screw-fastened to support the attachment assist member 35. Examples of the support body 40 include a support frame and a body of an apparatus or a device.

The support body 40 according to the first exemplary embodiment is configured as, for example, a support plate having a certain shape.

The support body 40 has a circular third screw hole 41 having a diameter Dn at a portion to which the attachment assist member 35 is to be screw-fastened. The diameter Dn of the third screw hole 41 is equal to the diameter Dn of the screw hole 23 when a screw fastener the same as the screw fastener 10 is used.

### Assembly of Assembly Structure

The assembly structure 4 is assembled in the following order: the attachment assist member 35 is attached to the support body 40 with a screw; the fastening assist member 20 of the screw fastening structure 1 is attached to the attachment assist member 35 with a screw; and the member to be fastened 30 is attached to the folded part 22 of the fastening assist member 20 with a screw.

More specifically, first, the attachment assist member 35 is attached to the support body 40 by letting the threaded portion 12 of a threaded fastener 10 through the third through-hole 38 in the attachment assist member 35 and fastening the threaded portion 12 with the third threaded hole 41 in the support body 40.

Subsequently, the fastening assist member 20 is attached to the attachment assist member 35 by letting the threaded portion 12 of another screw fastener 10 through the second through-hole 26 in the body part 21 of the fastening assist member 20 and fastening the threaded portion 12 with the second screw hole 36 in the attachment assist member 35.

Finally, the member to be fastened 30 is attached to the folded part 22 of the fastening assist member 20 by letting the threaded portion 12 of another screw fastener 10 through the through-hole 24 in the folded part 22 of the fastening assist member 20 and fastening the threaded portion 12 with the screw hole 23 in the folded part 22.

At this time, in the assembly structure 4, the threaded portion 12 of the screw fastener 10 is let through the through-hole 24 in the folded part 22 of the fastening assist member 20 of the screw fastening structure 1 and then fastened to the flanged screw hole 23.

Therefore, as described above, also in the assembly structure 4, compared with the screw fastening structure 1X according to the comparative example shown in FIG. 7A, when the screw fastener 10 is fastened to the flanged screw hole 23 in the screw fastening structure 1, deformation of the flange 25 of the screw hole 23 in such a manner that the flange 25 sinks is suppressed.

In the assembly structure 4, because multiple parts are screw-fastened, the tolerances are accumulated, leading to positional deviation between screw holes and through-holes. In the second exemplary embodiment, two parts, namely, the attachment assist member 35 and the fastening assist member 20, are the parts to be screw-fastened. However, the number of the parts to be screw-fastened may be more than two, and the cumulative tolerance increases with the number of parts to be fastened.

Therefore, in the assembly structure 4, to enable the screws to be smoothly and reliably fastened to the end, the diameters of the through-holes through which the threaded portions 12 of the screw fasteners 10 pass gradually increase with the order of fastening, taking into consideration the accumulation of tolerances.

However, if the diameter of the through-hole for the screw fastener 10 in the member to be fastened 30, which is screwed near the end of the order of fastening, is increased (the large-diameter through-hole 24), and a screw fastener 10 is fastened to the flanged screw hole 23, the flange 25 of the screw hole 23 is likely to be deformed so as to sink by fastening the screw fastener 10.

Hence, in the assembly structure 4, even though it has been desired to reduce the thickness J1 of the fastening assist member 20 to a value less than 1 mm (for example, about 0.6 mm) to reduce the weight, it has been difficult to reduce the thickness of the fastening assist member 20 because the above-described deformation is likely to occur when a flanged screw hole 23 is provided in the fastening assist member 20 having a small thickness J1.

In addition, when a flanged screw hole 23 is provided in a thin fastening assist member 20, the greater the diameter of the through-hole in the member to be fastened 30 that is to be screw-fastened and attached to the screw hole 23, the more likely the breaking torque, serving as an indication of the cause of screw breakage, is to decrease and the deformation is to occur. Hence, in this case, it has been more difficult to reduce the thickness of the fastening assist member 20.

In contrast, in the assembly structure 4 employing the screw fastening structure 1 according to the first exemplary embodiment, even when the thickness J1 of the fastening assist member 20 is smaller than 1 mm, deformation of the flange 25 of the screw hole 23 in the folded part 22 of the fastening assist member 20 in such a manner that the flange 25 sinks due to fastening of the screw fastener 10 is suppressed.

Moreover, in the assembly structure 4, even if the through-hole for the screw fastener 10 in the member to be fastened 30, which will be screw-fastened to the folded part 22 of the fastening assist member 20, is the large-diameter through-hole 31 having a large diameter, deformation of the flange 25 of the screw hole 23 in such a manner as described above due to the fastening of the screw fastener 10 is suppressed.

As a result, the weight of the assembly structure 4 can be reduced by, for example, reducing the thickness J1 of the fastening assist member 20.

In addition, in the assembly structure 4, when the diameter D2 of the second through-hole 26 in the body part 21 of the fastening assist member 20 of the screw fastening structure 1 is equal to the diameter D1 of the through-hole 24 in the folded part 22 of the fastening assist member 20 as described above, the following effects are obtained.

In the assembly structure 4, compared with a case where the diameter D2 of the second through-hole 26 in the fastening assist member 20 is greater than the diameter D1 of the through-hole 24 in the folded part 22 of the fastening assist member 20, deformation of a flange 37 of the flanged second screw hole 36 in the attachment assist member 35 in such a manner that it sinks into the second through-hole 26 due to fastening of the screw fastener 10 is less likely to occur.

### Modification of First Exemplary Embodiment

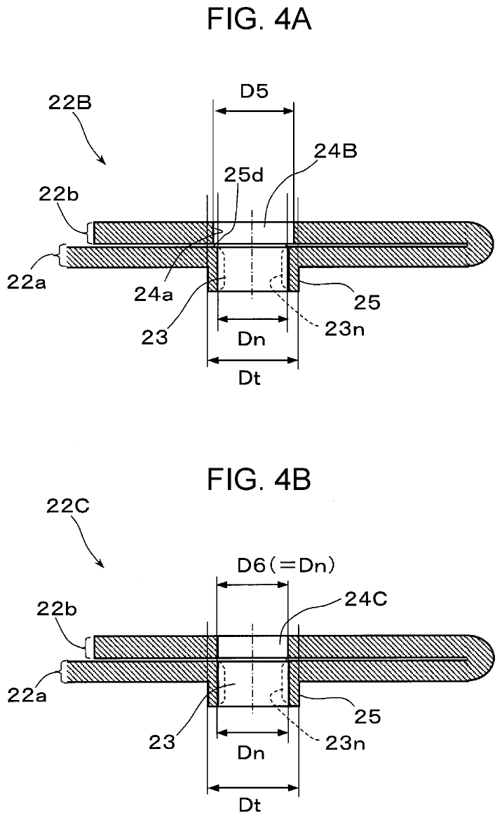

The folded part 22 of the fastening assist member 20 of the screw fastening structure 1 may be changed to a folded part 22B according to a first modification, as shown in FIG. 4A, in which a through-hole 24B, serving as the through-hole for the screw fastener 10, is provided such that an edge 24a thereof faces the bending root portion 25d of the flange 25 of the screw hole 23.

In this case, the diameter D5 of the through-hole 24B is greater than the diameter Dn of the screw hole 23 and smaller than the diameter Dt of the outer circumferential portion of the flange 25.

In the screw fastening structure 1 with the folded part 22B having the through-hole 24B according to the first modification, compared with a case where the through-hole is provided such that the edge 24a thereof faces a portion farther from the bending root portion 25d of the flange 25 of the screw hole 23, deformation of the flange 25 of the screw hole 23 in such a manner that it sinks due to fastening of the screw fastener 10 is suppressed.

Alternatively, the folded part 22 of the fastening assist member 20 of the screw fastening structure 1 may be changed to a folded part 22C according to a second modification, as shown in FIG. 4B, in which a through-hole 24C, serving as the through-hole for the screw fastener 10, having a diameter D6 equal to the diameter Dn of the screw hole 23 is provided.

In the screw fastening structure 1 with the folded part 22C having the through-hole 24C according to the second modification, compared with a case where the through-hole is provided such that the diameter D6 thereof is greater than the diameter Dn of the screw hole 23, deformation of the flange 25 of the screw hole 23 in such a manner that it sinks due to fastening of the screw fastener 10 is reliably suppressed.

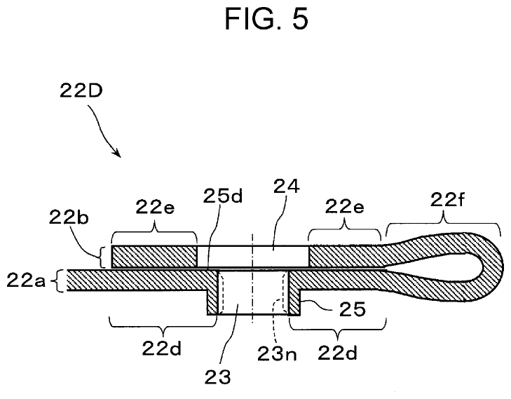

Alternatively, the folded part 22 of the fastening assist member 20 of the screw fastening structure 1 may be changed to a folded part 22D according to a third modification, as shown in FIG. 5, in which the base portion 22a, which is one portion of the folded part and has the screw hole 23, and the folded portion 22b, which is the other portion of the folded part and has the through-hole 24, are laid on each other such that a peripheral portion 22d of the screw hole 23 in the base portion 22a and a peripheral portion 22e of the through-hole 24 in the folded portion 22b are at least in contact with each other.

In this case, as shown in FIG. 5, in the folded part 22D, the base portion 22a and the folded portion 22b extending from a bent portion 22f, forming the folded portion 22D, are separated over a certain area.

The peripheral portion 22d of the screw hole 23 may be an area in the base portion 22a, the area including at least the bending root portion 25d of the flange 25 of the screw hole 23 and a certain peripheral portion thereof. Furthermore, the peripheral portion 22e of the through-hole 24 may be an area in the folded portion 22b, the area facing the area including at least the bending root portion 25d and a certain peripheral portion thereof.

In the screw fastening structure 1 with the folded part 22D according to the third modification, compared with a case where the base portion 22a and the folded portion 22b of the folded part are separated over the entire area where they face each other, deformation of the flange 25 of the screw hole 23 in such a manner that it sinks due to fastening of the screw fastener 10 is more likely to be suppressed.

### Second Exemplary Embodiment

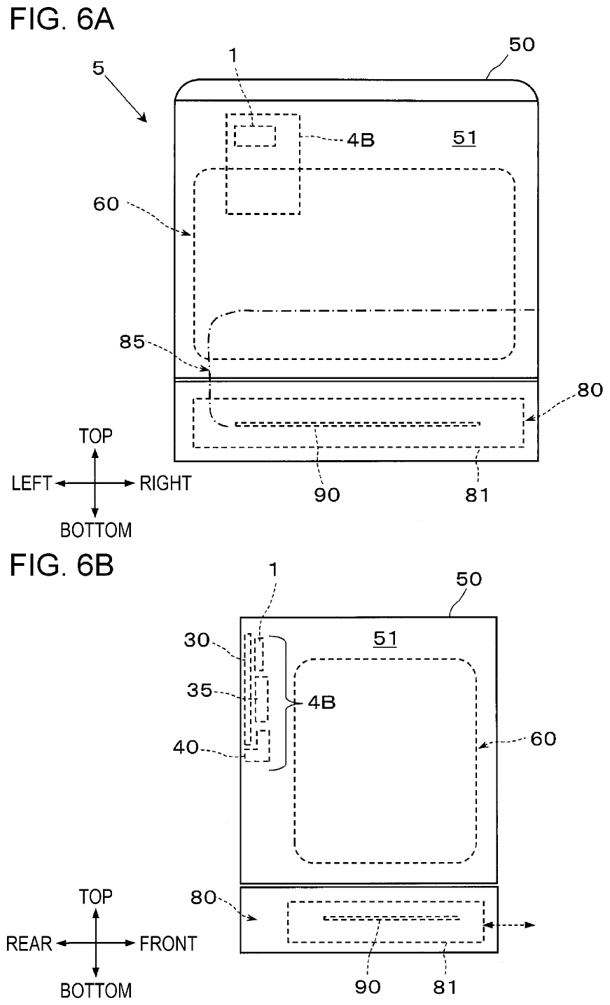

FIGS. 6A and 6B schematically show an image forming apparatus 5 according to a second exemplary embodiment of the present disclosure.

The image forming apparatus 5 is capable of forming an image and includes the screw fastening structure 1.

More specifically, as shown in FIGS. 6A and 6B, the image forming apparatus 5 includes: a housing 50 having an internal space 51; an image forming unit 60 that is disposed in the internal space 51 of the housing 50 and forms an image on a recording medium 90; a medium feed unit 80 that accommodates the recording medium 90 and feeds the recording medium 90 to the image forming unit 60; and the screw fastening structure 1.

The image forming unit 60 forms an image on a recording medium 90 on the basis of image information input from the outside.

The image forming unit 60 includes devices required by a certain image forming system, such as an electrophotographic system, an inkjet system, an electrostatic recording system, or a thermal recording system, and the related devices.

The medium feed unit 80 accommodates recording media 90 to be used in the image forming unit 60 and feeds a recording medium 90 to the image forming unit 60 at a desired time.

The medium feed unit 80 includes a container 81 that accommodates multiple recording media 90, and a feeding device (not shown) that feeds the recording media 90 accommodated in the container 81 to a medium transport path 85 connected to the image forming unit 60.

The recording media 90 may be any media on which an image can be formed by the image forming unit 60 and which can be transported by the medium transport path 85. The recording media 90 may be, for example, sheet-like media, such as paper and envelopes.

The medium transport path 85 transports a recording medium 90 fed out from the medium feed unit 80 so as to supply the recording medium 90 to the image forming unit 60 and transports the recording medium 90 to the outside (a medium container or the like) of the housing 50 after an image is formed on the recording medium 90 by the image forming unit 60. The medium transport path 85 includes multiple transport rollers that transport the recording medium 90 and a guide member that guides the recording medium 90 to a transport destination.

In the image forming apparatus 5, when the time for forming an image has come, the next image forming operation is performed.

Specifically, first, while the image forming unit 60 forms an image based on image information input from the outside in accordance with a certain image forming method, a recording medium 90 is fed from the medium feed unit 80, transported via the medium transport path 85, and supplied to the image forming unit 60. Subsequently, in the image forming unit 60, an image is formed on the supplied recording medium 90 by transfer, ejection, or the like. The recording medium 90 on which the image has been formed is discharged to the outside of the housing 50 via the medium transport path 85.

This way, the basic image forming operation by the image forming apparatus 5 is completed.

Next, the screw fastening structure 1 is used as a part (the above-described screw fastening structure) of the assembly structure 4B including: the member to be fastened 30 having the large-diameter through-hole 31 through which the threaded portion 12 of the screw fastener 10 passes; the screw fastening structure for fastening the member to be fastened 30 to the fastening assist member 20 with the screw fastener 10; the attachment assist member 35 to which the fastening assist member 20 is attached with a screw; and the support body 40 to which the attachment assist member 35 is attached with a screw.

In this case, the member to be fastened 30 is an inner cover, an outer cover, or the like.

The attachment assist member 35 is a bracket on which a component of an electronic device, an electric device, or the like is mounted. The above-mentioned component is mounted on a part of the attachment assist member 35.

Furthermore, the support body 40 is a support frame constituting a part of the housing 50.

Similarly to the screw fastening structure 1 according to the first exemplary embodiment and the modifications thereof (see FIGS. 1 to 5), the screw fastening structure 1 includes the screw fastener 10 and the fastening assist member 20 including: the flanged screw hole 23; the through-hole 24 for the screw fastener 10; and the folded part 22 folded back such that the screw hole 23 and the through-hole 24 face each other.

The fastening assist member 20 has the same configuration as the fastening assist member 20 according to the first exemplary embodiment and the modifications thereof.

At a certain time in the manufacturing process or the like of the image forming apparatus 5, the assembly structure 4B is assembled. The assembly structure 4B is assembled substantially in the same way as the assembly structure 4 described in the first exemplary embodiment.

In the assembling work, the member to be fastened 30, which is an inner cover or an outer cover, is fastened to the folded part 22 of the fastening assist member 20 of the screw fastening structure 1 with the screw fastener 10, similarly to the case of the screw fastening structure 1 or the assembly structure 4 according to the first exemplary embodiment.

Also in the image forming apparatus 5, when the screw fastener 10 is fastened to the flanged screw hole 23 in the screw fastening structure 1 (see FIGS. 1 and 3) in an assembly stage, in which the member to be fastened 30 is fastened to the folded part 22 of the fastening assist member 20 with a screw, deformation of the flange 25 of the screw hole 23 in such a manner that it sinks is suppressed, compared with the screw fastening structure 1X according to the comparative example illustrated in FIG. 7A, as described in the first exemplary embodiment.

Also in the assembly structure 4B in the image forming apparatus 5, similarly to the assembly structure 4 according to the first exemplary embodiment, it is possible to reduce the weight by, for example, reducing the thickness J1 of the fastening assist member 20 of the screw fastening structure 1.

### Other Modifications

Although the exemplary embodiments of the present disclosure have been described above, the present disclosure is not limited to the configurations described as the first exemplary embodiment (and the modifications thereof) and the second exemplary embodiment, and various modifications and implementations can be made without departing from the scope of the present disclosure. Hence, the present disclosure includes, for example, the modifications described below.

In the screw fastening structure 1 according to the first and second exemplary embodiments, multiple sets of the screw hole 23 and the through-hole 24 may be provided in the folded part 22 of the fastening assist member 20. In addition, the fastening assist member 20 may include multiple folded parts 22 having the screw holes 23 and the through-holes 24.

The assembly structure 4 employing the screw fastening structure 1 according to the first exemplary embodiment may be any type of device as long as it is a device to which the screw fastening structure 1 can be effectively applied. In other words, the assembly structure 4 may be used as the whole or a part of an apparatus other than the image forming apparatus 5.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A screw fastening structure comprising:
a screw fastener having a threaded portion; and
a fastening assist member having a flanged screw hole, a through-hole through which the threaded portion of the screw fastener passes, and a folded part folded back such that the screw hole and the through-hole face each other, wherein:
a flange of the screw hole projects toward a side opposite to a side of the through-hole; and
the threaded portion of the screw fastener is fastened to the screw hole after passing through the through-hole.
   (((2)))

The screw fastening structure according to (((1))), wherein an edge of the through-hole faces a bending root portion of the flange of the screw hole.

(((3)))

The screw fastening structure according to (((2))), wherein the diameter of the through-hole is equal to the diameter of the screw hole.

(((4)))

The screw fastening structure according to any one of (((1))) to (((3))), wherein the folded part has one portion provided with the screw hole and the other portion provided with the through-hole, and the one portion and the other portion are laid on each other such that at least a peripheral portion of the screw hole and a peripheral portion of the through-hole are in contact with each other.

(((5)))

The screw fastening structure according to (((4))), wherein the folded part is folded back such that the one portion and the other portion are in contact with each other over the entire area where the one portion and the other portion face each other.

(((6)))

The screw fastening structure according to any one of (((1))) to (((5))), further including a member to be fastened to the folded part of the fastening assist member with the screw fastener, wherein the member to be fastened has a large-diameter through-hole having a greater diameter than the through-hole.

(((7)))

An assembly structure comprising:
a member to be fastened having a large-diameter through-hole through which a threaded portion of a screw fastener passes; and
the screw fastening structure according to any one of (((1))) to (((6))), the screw fastening structure being configured to fasten the member to be fastened to a fastening assist member with the screw fastener.
   (((8)))

An image forming apparatus including the screw fastening structure according to any one of (((1))) to (((6))).

What is claimed is:

1. A screw fastening structure comprising:
a screw fastener having a threaded portion; and
a fastening assist member having a flanged screw hole, a through-hole through which the threaded portion of the screw fastener passes, and a folded part folded back such that the screw hole and the through-hole face each other, wherein:
a flange of the screw hole projects toward a side opposite to a side of the through-hole; and
the threaded portion of the screw fastener is fastened to the screw hole after passing through the through-hole.

2. The screw fastening structure according to claim 1, wherein an edge of the through-hole faces a bending root portion of the flange of the screw hole.

3. The screw fastening structure according to claim 2, wherein the diameter of the through-hole is equal to the diameter of the screw hole.

4. The screw fastening structure according to claim 1, wherein:
the folded part has one portion provided with the screw hole and the other portion provided with the through-hole; and
the one portion and the other portion are laid on each other such that at least a peripheral portion of the screw hole and a peripheral portion of the through-hole are in contact with each other.

5. The screw fastening structure according to claim 4, wherein the folded part is folded back such that the one portion and the other portion are in contact with each other over the entire area where the one portion and the other portion face each other.

6. The screw fastening structure according to claim 1, further comprising a member to be fastened to the folded part of the fastening assist member with the screw fastener,
wherein the member to be fastened has a large-diameter through-hole having a greater diameter than the through-hole.

7. An assembly structure comprising:
a member to be fastened having a large-diameter through-hole through which a threaded portion of a screw fastener passes; and
the screw fastening structure according to claim 1, the screw fastening structure being configured to fasten the member to be fastened to a fastening assist member with the screw fastener.

8. An assembly structure comprising:
a member to be fastened having a large-diameter through-hole through which a threaded portion of a screw fastener passes; and
the screw fastening structure according to claim 2, the screw fastening structure being configured to fasten the member to be fastened to a fastening assist member with the screw fastener.

9. An assembly structure comprising:
a member to be fastened having a large-diameter through-hole through which a threaded portion of a screw fastener passes; and
the screw fastening structure according to claim 3, the screw fastening structure being configured to fasten the member to be fastened to a fastening assist member with the screw fastener.

10. An assembly structure comprising:
a member to be fastened having a large-diameter through-hole through which a threaded portion of a screw fastener passes; and
the screw fastening structure according to claim 4, the screw fastening structure being configured to fasten the member to be fastened to a fastening assist member with the screw fastener.

11. An assembly structure comprising:
a member to be fastened having a large-diameter through-hole through which a threaded portion of a screw fastener passes; and
the screw fastening structure according to claim 5, the screw fastening structure being configured to fasten the member to be fastened to a fastening assist member with the screw fastener.

12. An assembly structure comprising:
a member to be fastened having a large-diameter through-hole through which a threaded portion of a screw fastener passes; and
the screw fastening structure according to claim 6, the screw fastening structure being configured to fasten the member to be fastened to a fastening assist member with the screw fastener.

13. An image forming apparatus comprising the screw fastening structure according to claim 1.

14. An image forming apparatus comprising the screw fastening structure according to claim 2.

15. An image forming apparatus comprising the screw fastening structure according to claim 3.

16. An image forming apparatus comprising the screw fastening structure according to claim 4.

17. An image forming apparatus comprising the screw fastening structure according to claim 5.

18. An image forming apparatus comprising the screw fastening structure according to claim 6.
